(19) United States
(12) Patent Application Publication
(10) Pub. No.: US 2019/0244035 A1
(43) Pub. Date: Aug. 8, 2019

(54) SURVEILLANCE APPARATUS, CONTROL METHOD, AND PROGRAM

(71) Applicant: NEC CORPORATION, Tokyo (JP)

(72) Inventors: Kenichiro Ida, Tokyo (JP); Mika Saito, Tokyo (JP); Ryoma Oami, Tokyo (JP); Junko Nakagawa, Tokyo (JP); Hiroshi Yamada, Tokyo (JP)

(73) Assignee: NEC CORPORATION, Tokyo (JP)

(21) Appl. No.: 16/388,260

(22) Filed: Apr. 18, 2019

Related U.S. Application Data
(63) Continuation of application No. 16/066,220.

(30) Foreign Application Priority Data
Dec. 28, 2015 (JP) 2015-255925

(51) Int. Cl. G06K 9/00; H04W 4/021; G01C 21/34

(52) U.S. Cl. CPC G06K 9/00778; G01C 21/3415; G01C 21/3461; H04W 4/021

(57) ABSTRACT

A surveillance apparatus (2000) includes a first calculation unit (2020), an extraction unit (2040), and a notification unit (2060). The first calculation unit (2020) calculates a risk index value in a first region (40) on a current route (20). The risk index value of the first region (40) indicates a degree of concern that a risk (such as crowd confusion) caused by congestion of people occurs in the first region (40). For calculation of the risk index value in the first region (40), a captured image generated by a camera (50) is used. The extraction unit (2040) extracts a bypass route (30) when the risk index value of the first region (40) is equal to or greater than a predetermined threshold value. The notification unit (2060) notifies a user that a route through which a person is caused to pass is to be switched to the extracted bypass route (30).

### CROSS REFERENCE TO RELATED APPLICATIONS

This application is a Continuation of U.S. application Ser. No. 16/066,220 filed Jun. 26, 2018, which is a National Stage of International Application No. PCT/JP2016/084405 filed Nov. 21, 2016, claiming priority based on Japanese Patent Application No. 2015-255925 filed Dec. 28, 2015, the disclosures of which are incorporated herein in their entirety.

### TECHNICAL FIELD

The present invention relates to a surveillance apparatus, a control method, and a program.

### BACKGROUND ART

Risks such as an accident or confusion caused by congestion of people may occur on a route through which people pass. An example of such a route is a route between an event venue and a station closest to the event venue. Such a route is used by a large number of people participating in an event. Therefore, for example, when people gather at a certain place on the route, confusion may occur.

In order to avoid such risks, crowd guarding is performed by security guards or the like. The crowd guarding is an operation such as traffic regulation which is performed to prevent risks that are caused by a large number of people gathering at a specific place due to various events or the like. For example, when people accumulate on a main route from a station closest to an event venue to the event venue, the security guards guide subsequent people to a route bypassing the main route (hereinafter referred to as a bypass route). Accordingly, risks are prevented from occurring in the main route.

More specifically, for example, a security guard deployed on the field periodically reports a congestion situation on the field to the security headquarters. Further, according to instructions from the security headquarters, the onsite security guard performs passing prohibition control on a main route or performs switching to a bypass route, or the like.

Further, surveillance cameras are used in crowd guarding. For example, the security headquarters recognize a situation of the field using images of the surveillance cameras, in addition to reporting from security guards. The security headquarters determines performance of an operation such as switching to a bypass route, and performs an instruction to the onsite security guards.

Further, an apparatus for facilitating crowd guarding has been developed. Patent Document 1 discloses an apparatus that predicts the amount of inflow and outflow of people, a density of people, or the like in a warning target region such as an event venue. In this apparatus, the amount of inflow and outflow of people at a surrounding point is measured by analyzing images generated by a camera installed at the surrounding point of the event venue or the like. This apparatus predicts, for example, the amount of inflow and outflow of people or a density of the people in the warning target region using the measured amount of inflow and outflow of the people, and prediction data of the amount of inflow and outflow of people at an inflow and outflow point of a relevant transportation facility. A result of the prediction is used to plan subsequent traffic regulation.

Patent Document 2 discloses a system that calculates the density of people at a railroad station using images of a surveillance camera. Patent Document 2 describes that a usage example in which a warning is generated when the density of the people is high can be considered.

### RELATED DOCUMENT

### Patent Document

[Patent Document 1] Japanese Patent Application Publication No. 2004-178358

[Patent Document 2] US Patent Application Publication No. 2008/0106599

### SUMMARY OF THE INVENTION

### Technical Problem

In actual crowd guiding, reporting of an onsite security guard to the security headquarters or video surveillance at the security headquarters may not be appropriately performed. First of all, the onsite security guard should respond to an event occurring suddenly on the field. For example, the onsite security guard gives directions when asked for directions by a person. Therefore, reporting to the security headquarters may be delayed, or report leakage may occur. Further, the security headquarters may have to surveil a plurality of surveillance videos at the same time. In such a case, even when a situation in which people are accummulated at a specific place is captured in the video of the surveillance camera, the security headquarters may overlook the video. As a result, there is concern that a risk such as confusion of the crowd may occur.

By using the apparatus of Patent Document 1, the security headquarters can plan a prospective traffic regulation on the basis of a predicted value of the amount of inflow and outflow of people in a security target region. However, it is necessary to manually determine which place to regulate traffic.

By using the system of Patent Document 2, it is possible to recognize that people are accummulated at the station. However, it is necessary for coping that is performed when the accumulated people have been recognized to be manually considered.

The present invention has been made in view of the above problems. An object of the present invention is to provide a technology for preventing a risk caused by congestion of people from occurring.

A surveillance apparatus of the present invention includes: 1) a first calculation unit calculating a first risk index value using a captured image in which a current route through which a person is caused to pass, the first risk index value indicating a degree of concern that a risk caused by congestion of people may occur in a first region on the current route; 2) an extraction unit extracting one of one or more bypass routes that are defined for the current route when the first risk index value is equal to or greater than a first threshold value; and 3) a notification unit notifying that a route through which the person is caused to pass is to be switched from the current route to the extracted bypass route.

A control method of the present invention is a control method that is executed by a computer. The control method includes: 1) a first calculation step of calculating a first risk index value using a captured image obtained by imaging a current route through which a person is caused to pass, the first risk index value indicating a degree of concern that a risk caused by congestion of people may occur in a first region on the current route; 2) an extraction step of extracting one of one or more bypass routes that are defined for the current route when the first risk index value is equal to or greater than a first threshold value; and 3) a notification step of notifying that a route through which the person is caused to pass is to be switched from the current route to the extracted bypass route.

A program of the present invention causes a computer to execute each step of the control method of the present invention to operate the computer as the surveillance apparatus of the present invention.

### Advantageous Effects of Invention

According to the present invention, a technology for preventing a risk caused by congestion of people from occurring is provided.

### BRIEF DESCRIPTION OF THE DRAWINGS

The above objects, other objects, features and advantages will become more apparent from preferred example embodiments to be described below and the accompanying drawings.

FIG. 1 is a diagram conceptually illustrating an operation of a surveillance apparatus according to Example Embodiment 1.
FIG. 2 is a block diagram illustrating the surveillance apparatus according to Example Embodiment 1.

FIG. 3 is a diagram illustrating a configuration of a computer that realizes the surveillance apparatus.

FIG. 4 is a flowchart illustrating a flow of a process that is executed by the surveillance apparatus according to Example Embodiment 1.

FIG. 5 is a diagram illustrating a scene in which surroundings of a first region are imaged.

FIG. 6 is a diagram illustrating Equation (2).

FIG. 7 is a diagram illustrating bypass route information in a table format.

FIG. 8 is a block diagram illustrating a surveillance apparatus including a bypass route information storage unit.

FIG. 9 is a diagram illustrating a plurality of bypass routes that are determined for one main route.

FIG. 10 is a diagram illustrating route information under an operation in which a certain bypass route can also serve as a main route.

FIG. 11 is a diagram conceptually illustrating an operation of a surveillance apparatus according to Example Embodiment 2.

FIG. 12 is a block diagram illustrating the surveillance apparatus according to Example Embodiment 2.

FIG. 13 is a flowchart illustrating a flow of a process that is executed by the surveillance apparatus according to Example Embodiment 2.

FIG. 14 is a diagram illustrating route information indicating a second region.

### DESCRIPTION OF EMBODIMENTS

Hereinafter, example embodiments of the present invention will be described with reference to the drawings. In all the drawings, the same components are denoted with the same reference numerals, and description thereof will be appropriately omitted. In each block diagram other than the hardware configuration diagram, each block does not indicate a configuration in units of hardware, but indicates a configuration in units of a function.

### Example Embodiment 1

FIG. 1 is a diagram conceptually illustrating an operation of a surveillance apparatus 2000 according to Example Embodiment 1. A current route 20 is a route through which a person is currently caused to pass. The bypass route 30 is one of the bypass routes provided corresponding to the current route 20. The camera 50 is a camera that images the current route 20.

The surveillance apparatus 2000 calculates a risk index value in a first region 40 on the current route 20. The risk index value of the first region 40 indicates a degree of concern that a risk (such as crowd confusion) caused by congestion of people in the first region 40 may occur. For the calculation of the risk index value of the first region 40, the captured image generated by the camera 50 is used. When the risk index value of the first region 40 is equal to or greater than a predetermined threshold value, the surveillance apparatus 2000 notifies the user of the fact that the route through which the person is caused to pass is to be switched from the current route 20 to the bypass route 30. The user of the surveillance apparatus 2000 is, for example, a security guard 10 that guards the current route 20 or its surroundings. The security guard may be a person who performs security on the field (the current route 20 or its surroundings) or may be a person who performs security by looking at an image of a surveillance camera at a security headquarters or the like.

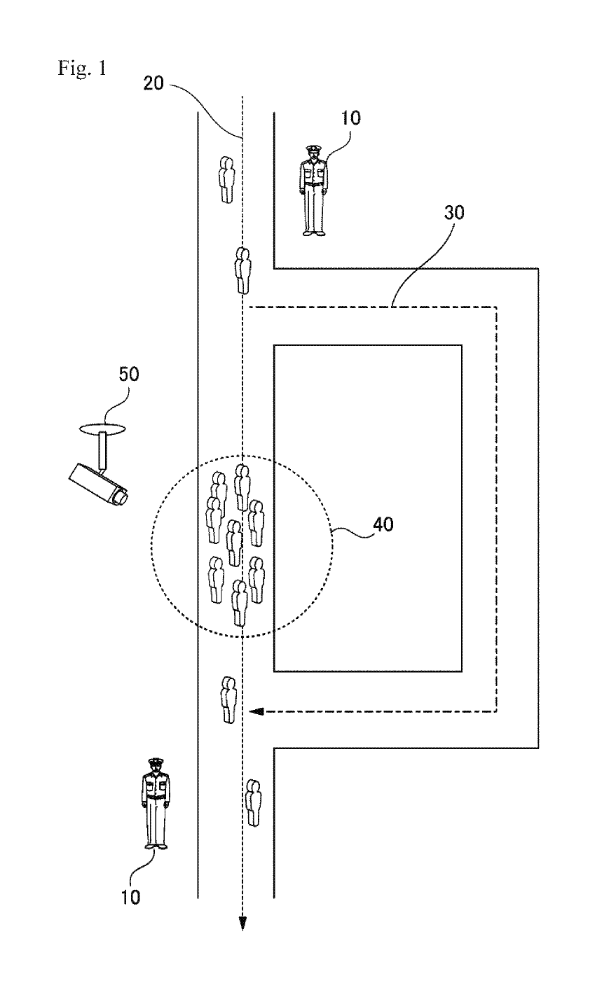

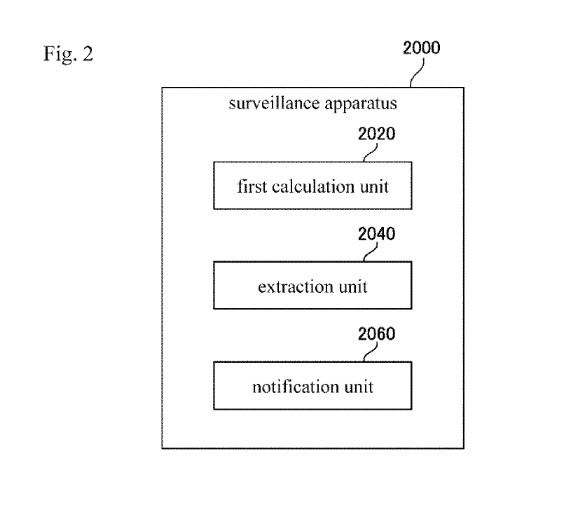

FIG. 2 is a block diagram illustrating the surveillance apparatus 2000 according to Example Embodiment 1. The surveillance apparatus 2000 includes a first calculation unit 2020, an extraction unit 2040, and a notification unit 2060. The first calculation unit 2020 calculates a risk index value in the first region 40 on the current route 20.

For the calculation of the risk index value in the first region 40, the captured image generated by the camera 50 is used. When the risk index value of the first region 40 is equal to or greater than the predetermined threshold value, the extraction unit 2040 extracts the bypass route 30. The notification unit 2060 notifies the user of the fact that a route through which a person is caused to pass is to be switched to the extracted bypass route 30.

### Advantageous Effects

According to the example embodiment, when the risk index value in the first region 40 on the current route 20 becomes equal to or greater than the threshold value, the bypass route 30 is extracted. A user such as a security guard is notified of the fact that the route through which the person is caused to pass is to be switched to the bypass route 30. Therefore, by using the surveillance apparatus 2000 according to the example embodiment, it is possible to more reliably recognize a situation in which concern that a risk may occur in the current route 20 is high, as compared with a method of directly viewing and confirming a situation of the current route 20 or a method of viewing an image of a surveillance camera and confirming a situation of the current route 20. Therefore, it is possible to prevent a risk from occurring on the current route 20 with higher probability.

Further, according to the surveillance apparatus 2000 of the example embodiment, in a case where concern that a risk caused by congestion of people may occur on the current route 20 is high, the bypass route 30 that is one of the bypass routes corresponding to the current route 20 is automatically extracted. Therefore, it is possible to easily perform the determination of the bypass route 30, as compared with a case where a security guard or the like manually determines the bypass route 30.

Hereinafter, the surveillance apparatus 2000 of the example embodiment will be described in more detail.

<Example of Hardware Configuration of Surveillance Apparatus 2000>

Each functional configuration unit of the surveillance apparatus 2000 may be realized by hardware (for example, hard-wired electronic circuit) that realizes each functional configuration unit, or may be realized by a combination of hardware and software (for example, a combination of an electronic circuit and a program for controlling the circuit). Hereinafter, a case where each functional configuration component of the surveillance apparatus 2000 is realized by a combination of hardware and software will be further described.

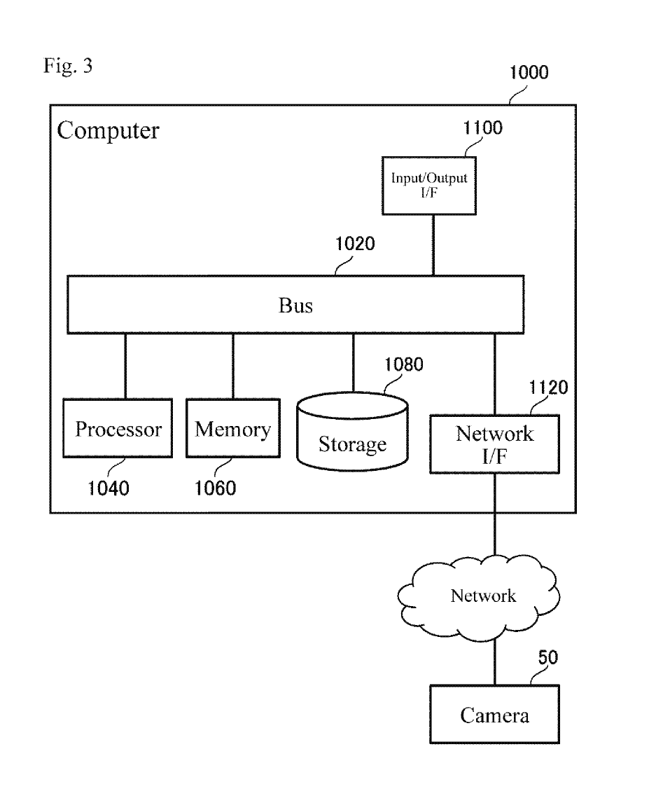

FIG. 3 is a diagram illustrating a configuration of a computer 1000 that realizes the surveillance apparatus 2000. The computer 1000 is realized by various computers such as a personal computer (PC), a server apparatus, or a mobile terminal. Further, the computer 1000 may be realized by the camera 50.

The computer 1000 has a bus 1020, a processor 1040, a memory 1060, a storage 1080, an input and output interface 1100, and a network interface 1120. The bus 1020 is a data transmission path through which the processor 1040, the memory 1060, the storage 1080, the input and output interface 1100, and the network interface 1120 transmit and receive data to and from each other. However, a method of connecting the processor 1040 and the like to each other is not limited to a bus connection. The processor 1040 is a processor such as a central processing unit (CPU) or a graphics processing unit (GPU). The memory 1060 is a memory such as a random access memory (RAM) or a read only memory (ROM). The storage 1080 is a storage apparatus such as a hard disk, a solid state drive (SSD), or a memory card. Further, the storage 1080 may be a memory such as a RAM or a ROM.

The input and output interface 1100 is an interface for connecting the computer 1000 to an input and output apparatus. For example, a keyboard or a display apparatus is connected to the input and output interface 1100.

The network interface 1120 is an interface for connecting the computer 1000 to a network such as the Internet. For example, the computer 1000 is connected to the camera 50 over a network. However, the computer 1000 may not be connected to the camera 50.

The storage 1080 stores a program module that realizes respective functions of the surveillance apparatus 2000 (for example, functions of the first calculation unit 2020, the extraction unit 2040, and the notification unit 2060). The processor 1040 realizes the respective functions corresponding to the program modules (for example, functions of the first calculation unit 2020, the extraction unit 2040, and the notification unit 2060) by executing the respective program modules. Here, when the processor 1040 executes the respective modules, the processor 1040 may read the modules onto the memory 1060 and execute the modules, or may execute the modules without reading the modules onto the memory 1060.

A hardware configuration of the computer 1000 is not limited to the configuration illustrated in FIG. 3. For example, each program module may be stored in memory 1060. In this case, the computer 1000 may not include the storage 1080.

<<Regarding Camera 50>>

The camera 50 is an arbitrary imaging apparatus capable of imaging the current route 20. For example, the camera 50 is a surveillance video camera. Note that the current route 20 may be an outdoor route or may be an indoor route. Therefore, the camera 50 may be provided outdoors or may be provided indoors.

The camera 50 may be a camera the position of which is fixed (hereinafter referred to as a fixed camera), or may be a camera the position of which is not fixed (hereinafter referred to as a moving camera). Fixed cameras are installed in various places, such as, a wall, a pillar, or a ceiling. Note that the wall or the like at which the fixed camera is installed is not limited to real estate as long as its position is fixed for a certain period (for example, while an event requiring crowd guidance is being held). For example, a wall or a pillar at which the fixed camera is installed may be a partition or a pillar that is temporarily installed at an event venue or the like. Further, the fixed camera is not limited to be permanently installed. For example, the fixed camera may be provided only while an event requiring crowd guidance is being held.

For example, a moving camera is worn by a person, or is attached to a car, a motorcycle, a flying object, or the like. The moving camera worn by a person is, for example, a camera that is held by hand (a video camera, or a camera of a mobile terminal such as a smartphone), or a camera that is fixed to a head, a chest, or the like (a wearable camera, or the like). A camera attached to a car, a motorcycle, a flying object, or the like may be a camera that is attached for use as a so-called drive recorder, or may be a camera separately attached for surveillance and imaging.

The camera 50 that generates the captured image used for calculation of the risk index value of the first region 40 is a fixed camera that is installed near the first region 40 or a moving camera that moves near the first region 40. However, the camera 50 that generates the captured image used for calculation of the risk index value of the first region 40 is not limited to the illustrated camera.

As described above, the computer 1000 may be realized by the camera 50. In this case, the camera 50 calculates a risk index value in the first region 40 on the current route 20 using the captured image generated by imaging the current route 20 (the first calculation unit 2020). Further, when the risk index value of the first region 40 is equal to or greater than the predetermined threshold value, the camera 50 extracts the bypass route 30 (the extraction unit 2040). Further, the camera 50 notifies the user of the fact that the route through which the person is caused to pass is to be switched to the extracted bypass route 30 (the notification unit 2060).

Further, some of the functions of the surveillance apparatus 2000 rather than all the functions of the surveillance apparatus 2000 may be realized by the camera 50. For example, the function of the first calculation unit 2020 among the functions of the surveillance apparatus 2000 is realized by the camera 50, and the other functions are realized by the server apparatus. In this case, the risk index value calculated by the camera 50 is provided to the server apparatus. Further, for example, the function of the first calculation unit 2020 and the function of the extraction unit 2040 are realized by the camera 50, and the other functions are realized by the server apparatus. In this case, the bypass route 30 extracted by the camera is provided to the server apparatus.

For example, a camera called an intelligent camera, a network camera, an Internet protocol (IP) camera, or the like can be used as the camera 50 having some or all of the functions of the surveillance apparatus 2000.

<Flow of Process>

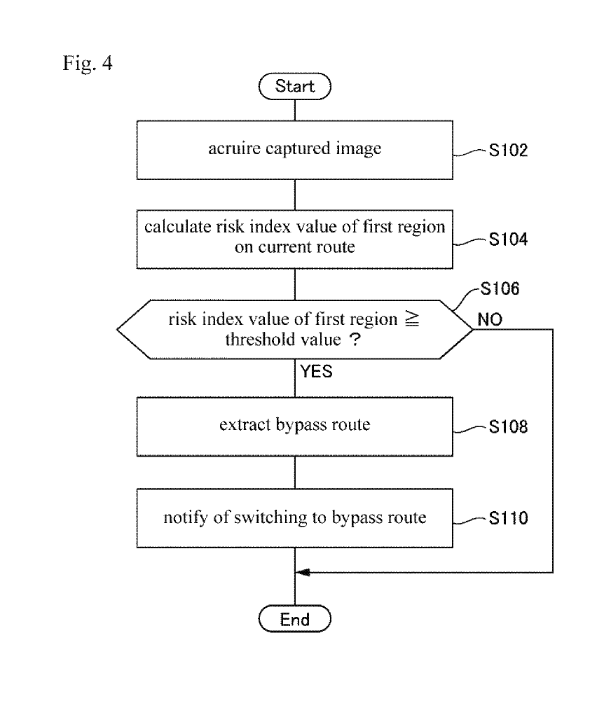

FIG. 4 is a flowchart illustrating a flow of a process that is executed by the surveillance apparatus 2000 according to Example Embodiment 1. The surveillance apparatus 2000 acquires a captured image generated by the camera 50 (S102). The first calculation unit 2020 calculates the first risk index value of the first region 40 on the current route 20 (S104). The extraction unit 2040 determines whether or not the risk index value is equal to or greater than the threshold value (S106). When the risk index value is equal to or greater than the threshold value (S106: YES), the process in FIG. 4 proceeds to 5108. On the other hand, when the risk index value is smaller than the threshold value (S106: NO), the process of FIG. 4 ends.

In S108, the extraction unit 2040 extracts the bypass route 30. The notification unit 2060 notifies the user of switching to the bypass route 30 (S110).

<Method of Acquiring Captured Image>

The surveillance apparatus 2000 acquires a captured image generated by the camera 50 (S102). There are various ways in which the surveillance apparatus 2000 acquires the captured image. For example, the surveillance apparatus 2000 acquires the captured image from the camera 50. In this case, the surveillance apparatus 2000 and the camera 50 are communicatably connected to each other.

Further, when the camera 50 stores the captured image in an external storage apparatus, the surveillance apparatus 2000 acquires the captured image from the storage apparatus. In this case, the surveillance apparatus 2000 is communicatably connected to this storage apparatus.

Note that a plurality of cameras 50 may be provided. In this case, the surveillance apparatus 2000 acquires the captured images generated by the respective cameras 50.

There are various timings at which the surveillance apparatus 2000 acquires the captured image generated by the camera 50. For example, the surveillance apparatus 2000 acquires the generated captured image at a timing at which the captured image is generated by the camera 50. Further, for example, the surveillance apparatus 2000 may periodically acquire a captured image generated by the camera 50.

Note that when the surveillance apparatus 2000 is realized by the camera 50, the surveillance apparatus 2000 acquires a captured image generated by the surveillance apparatus 2000 itself. In this case, the captured image is stored in, for example, the memory 1060 or the storage 1080 (see FIG. 3) inside the surveillance apparatus 2000.

<Regarding First Region 40>

The first region 40 may be an arbitrary place on the current route 20. For example, the first calculation unit 2020 treats a region captured in the captured image generated by the camera 50 as the first region 40. Here, when there are a plurality of cameras 50 and these cameras 50 image different regions, the surveillance apparatus 2000 may treat each of different regions captured by the plurality of cameras 50 as the first region 40. When there are a plurality of the first regions 40, the surveillance apparatus 2000 may perform, for example, notification of calculation of the risk index value and the switching to the bypass route, for each of the plurality of first regions 40.

The first calculation unit 2020 may acquire information indicating association of the current route 20 with the first region 40 (hereinafter referred to as surveillance route information). In this case, the first calculation unit 2020 recognizes one or a plurality of first regions 40 using the surveillance route information. In this case, the first region 40 may be a region not captured in the captured image generated by the camera 50.

<Method for Calculating Risk Index Value>

The first calculation unit 2020 calculates a risk index value of the first region 40 using the captured image (S104). There are various ways in which the first calculation unit 2020 calculates the risk index value. Hereinafter, a method of calculating the risk index value will be illustrated.

<<Density of Persons>>

For example, the first calculation unit 2020 calculates the density of the people in the first region 40 as the risk index value. In this case, the first calculation unit 2020 performs image processing on the captured image captured by the camera 50 to calculate the number of people appearing in the captured image. The first calculation unit 2020 calculates the density of the people in the first region 40 on the basis of the calculated number of people.

For example, the first calculation unit 2020 treats the calculated number of people as the density of the people in the first region 40. Further, for example, the first calculation unit 2020 calculates the density of the people in the first region 40 by dividing the calculated number of people by an area of the first region 40 captured in the captured image.

<<Temporal Change in Density of Persons>>

For example, the first calculation unit 2020 calculates a temporal change in the density of the people in the first region 40 as the risk index value. The temporal change in the density of the people in the first region 40 is a change in the density of the people per unit time (for example, one second) in the first region 40. The first calculation unit 2020 calculates the density of the people in the first region 40 at each point in time on the basis of a plurality of respective captured images generated at different points in time. The first calculation unit 2020 calculates the temporal change in the density of the people using the calculated density of the people at each point in time.

<<Speed of Person>>

For example, the first calculation unit 2020 calculates the speed of a person in the first region 40 as the risk index value of the first region 40. For example, it is assumed that one person has passed through the first region 40. In this case, the first calculation unit 2020 calculates the speed of the person on the basis of a change in a position of the person in the plurality of captured images. Further, for example, the first calculation unit 2020 may calculate the speed of the person from a magnitude of blur of the person in the captured image in which the person is captured.

When a plurality of people pass through the first region 40, for example, the first calculation unit 2020 calculates the speed of each of the plurality of people in the first region 40, and calculates a statistical value (an average value, a maximum value, a minimum value, or the like) of the calculated speed as the risk index value.

Note that when a person moving in a direction opposite to a moving direction of the person in the current route 20 (a direction from the start point to the end point of the current route 20) is captured in the captured image, the first calculation unit 2020 may exclude the person moving in the reverse direction from a calculation target of the risk index value.

<<Temporal Change in Speed of Person>>

For example, the first calculation unit 2020 calculates a temporal change (acceleration) of the speed of the person in the first region 40 as the risk index value of the first region 40. The temporal change in the speed of the person in the first region 40 is a change in the speed of the person per unit time (for example, one second) in the first region 40. The first calculation unit 2020 calculates the speed of the person in the first region 40 at different points in time. Then, the first calculation unit 2020 calculates the temporal change in the speed of the person using the speed of the person at each calculated point in time.

<<Combination of Plurality of Schemes>>

The first calculation unit 2020 may calculate a risk index value using any two or more of the density of people, the temporal change in the density of people, the speed of the person, and the temporal change in the speed of the person. For example, the first calculation unit 2020 calculates the risk index value using Equation (1) below. In each equation, r is the risk index value, d is the density of the people, f is the temporal change in the density of the people, v is the speed of the person, and a is the temporal change in the speed of the person.

### [Equation 1]

r=d*f*v*a (1)

<<Use of Attribute of Persons>>

When the attributes of people included in the crowd are different even when a value of the density or the speed of people are the same, concern that a risk may occur may increase. For example, when the crowd includes senior people or children, it can be said that concern of risk occurrence increases, as compared with a case where the people included in the crowd are only young adults.

Therefore, the first calculation unit 2020 may calculate the attribute (age or sex) of the person located in the first region 40 and adjust the risk index value calculated using the above-described method on the basis of the calculated attribute. For example, the first calculation unit 2020 analyzes the captured image and estimates the age of the person located in the first region 40. Further, the first calculation unit 2020 calculates a ratio of children (for example, people who are 10 years old or younger) or elderly (for example, a person who is 70 years old or older) to the number of people located in the first region 40. The first calculation unit 2020 adjusts the risk index value by multiplying the risk index value by the calculated ratio of the children or the senior people.

<Regarding Case Where First Region 40 is Not Captured in Captured Image>

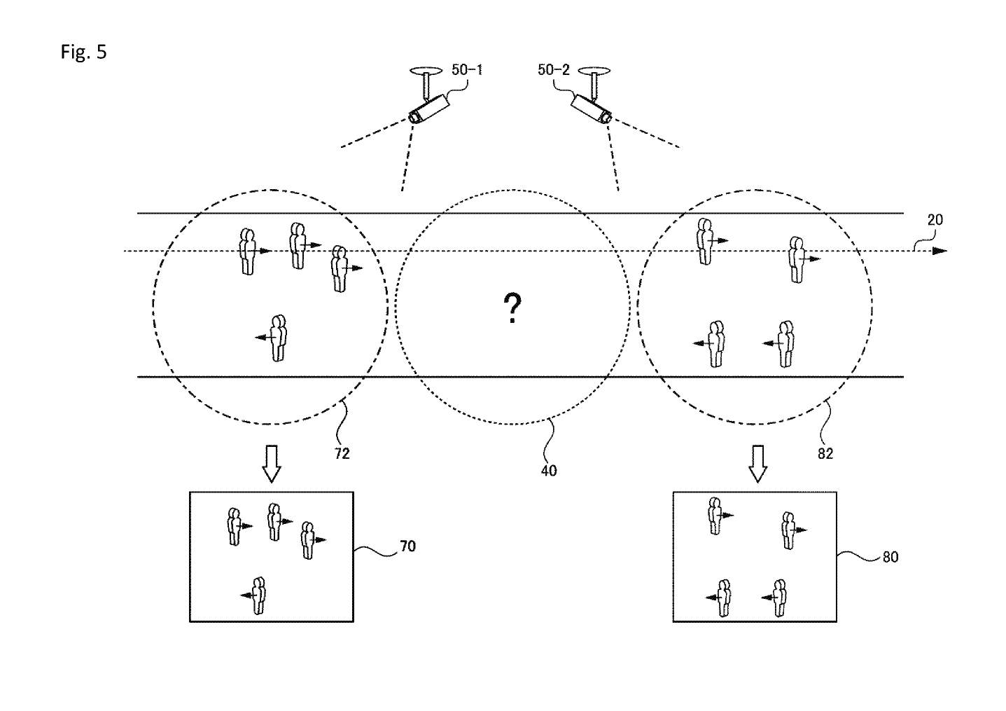

The first calculation unit 2020 may calculate the risk index value of the first region 40 using the captured image in which the first region 40 is not captured. In this case, it is assumed that the surroundings of the first region 40 are captured in the captured image. FIG. 5 is a diagram illustrating a scene in which surroundings of the first region 40 are imaged. The first calculation unit 2020 uses two images including a captured image 70 and a captured image 80. In the captured image 70, a region in front of the first region 40 is captured in the traveling direction of the person in the current route 20. On the other hand, in the captured image 80, a region behind the first region 40 is captured in the traveling direction of the person in the current route 20.

<<Density of Persons>>

For example, the first calculation unit 2020 uses the captured image 70 and the captured image 80 to calculate the density of the people in the region 72 and the region 82. The first calculation unit 2020 calculates an estimated value of the density of the people in the first region 40 using the density of the people in the two regions. The first calculation unit 2020 uses this estimated value as a risk index value. For example, the first calculation unit 2020 sets an average value of the density of the people in the region 72 and the density of the people in the region 82 as the estimated value of the density of the people in the first region 40.

Further, for example, the first calculation unit 2020 may calculate the estimated value of the density of the people in the first region 40 using Equation (2) below.

### [Equation 2]

dₑ(k)=dₑ(k−1)+n_{fo}(k)+n_{bo}(k)−n_{fi}(k)−n_{bi}(k) (2)

dₑ(k) indicates an estimated value of the density of people that is estimated at the k-th time. n_{fo}(k) indicates the number of people outflowing toward a direction in which the first region 40 is located from the region (region 72) located in front of the first region 40 between calculation of dₑ(k−1) and calculation of dₑ(k). nₙ(k) indicates the number of people who have flowed into the region 72 from the direction in which the first region 40 is located between calculation of dₑ(k−1) and calculation of dₑ(k). n_{be}(k) indicates the number of people outflowing toward a direction in which the first region 40 is located from the region (region 82) located in front of the first region 40 between calculation of dₑ(k−1) and calculation of dₑ(k). n_{bi}(k) indicates the number of people who have flowed into the region 82 from the direction in which the first region 40 is located between calculation of dₑ(k−1) and calculation of dₑ(k).

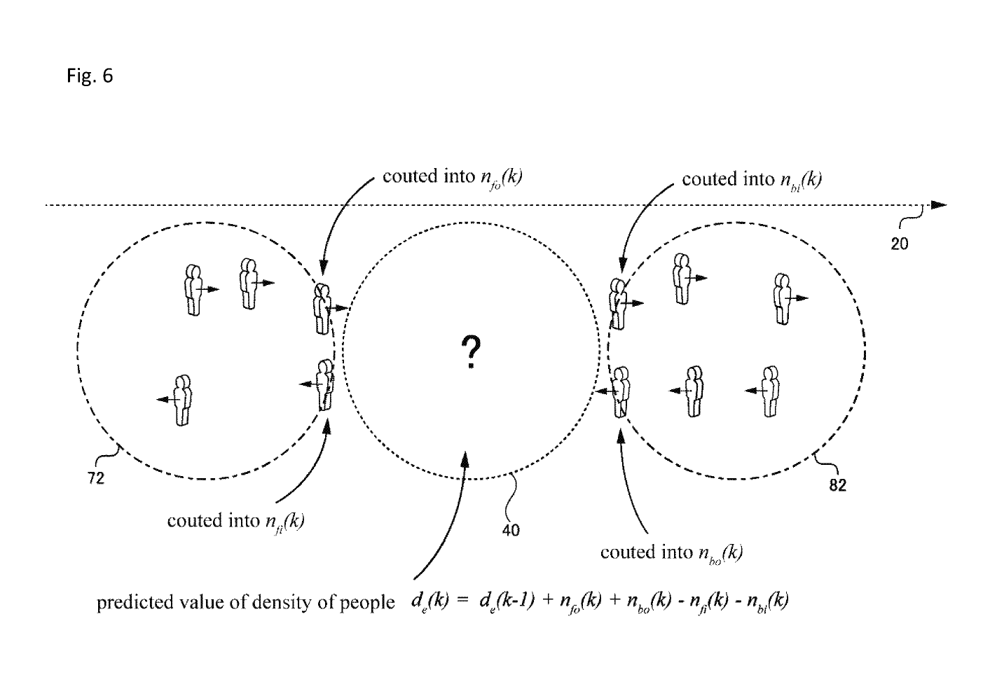

FIG. 6 is a diagram illustrating Equation (2). A person moving in a right direction in the region 72 in FIG. 6 is directed to the first region 40. Therefore, the first calculation unit 2020 counts the number of people outflowing in the right direction from the region 72 between the calculation of de(k−1) and the calculation of dₑ(k), and sets a sum of the counted people to n_{fo}(k). Further, the first calculation unit 2020 counts the number of people flowing into the region 72 in the right direction between calculation of dₑ(k−1) and calculation of dₑ(k), and sets a sum of the counted people to nₙ(k).

A person moving in a left direction in the region 82 in FIG. 6 is directed to the first region 40. Therefore, the first calculation unit 2020 counts the number of people outflowing in the left direction from the region 82 between the calculation of dₑ(k−1) and the calculation of dₑ(k), and sets a sum of the counted people to n_{bo}(k). Further, the first calculation unit 2020 counts the number of people flowing into the region 82 in the left direction between the calculation of dₑ(k−1) and the calculation of dₑ(k), and sets a sum of the counted people to n_{bi}(k).

Note that a method of determining the value of dₑ(0) which is an initial value of dₑ is arbitrary. For example, in a case where calculation of dₑ is started from a time when there are few passengers, the first calculation unit 2020 may set dₑ(0) to 0.

<<Temporal Change in Density of Persons>>

For example, the first calculation unit 2020 calculates the temporal change in the density of the people moving toward the first region 40 and the temporal change in the density of the people moving in a direction opposite to the first region 40 for each of the captured image 70 and the captured image 80. The first calculation unit 2020 calculates an estimated value of the temporal change in the density of the people in the first region 40 using the calculated values. The first calculation unit 2020 uses the estimated values as a risk index value. For example, the first calculation unit 2020 calculates an average value of the temporal change in the density of the people in the region 72 and the temporal change in the density of the people in the region 82, and uses this average value as the risk index value.

<<Speed of Person>>

For example, the first calculation unit 2020 calculates the speed of the person in the region 72 and the region 82 using the captured image 70 and the captured image 80. The first calculation unit 2020 calculates an estimated value of the speed of the person in the first region 40 using the speed of the person in the two regions. The first calculation unit 2020 uses this estimated value as a risk index value. For example, the first calculation unit 2020 sets an average value of the speed of the person in the region 72 and the speed of the person in the region 82 as the estimated value of the speed of the person in the first region 40.

<<Temporal Change of Speed of Person>>

For example, the first calculation unit 2020 calculates a temporal change in the speed of the person in the region 72 and the region 82 using the captured image 70 and the captured image 80. The first calculation unit 2020 calculates an estimated value of the temporal change in the speed of the person in the first region 40 using the time of the speed of the person in the two regions. The first calculation unit 2020 uses this estimated value as a risk index value. For example, the first calculation unit 2020 uses the average value of the temporal change in the speed of the person in the region 72 and the temporal change in the speed of the person in the region 82 as the estimated value of the speed of the person in the first region 40.

By estimating the risk index value of the first region 40 using each of the above-described schemes, a place not included in an imaging range of the camera 50 is treated as the first region 40, and concern of risk occurrence at that place can be recognized. Therefore, since the number of cameras 50 can be smaller than the number of places treated as the first region 40, it is able to reduce the number of cameras 50 to be installed for introducing the surveillance apparatus 2000. Therefore, an introduction cost of the surveillance apparatus 2000 can be reduced. Further, by estimating the risk index value of the first region 40 using each of the above-described schemes, even when an existing camera already installed in a route to an event venue or the like is used as the camera 50, a range that is not captured in the existing camera can be treated as the first region 40. Therefore, it is easy to introduce the surveillance apparatus 2000 that has utilized the existing camera.

<Timing at which Risk Index Value is Calculated>

A timing at which the first calculation unit 2020 calculates the risk index value of the first region 40 is arbitrary. For example, the first calculation unit 2020 calculates the risk index value of the first region 40 at predetermined time intervals. Further, for example, the first calculation unit 2020 calculates the risk index value of the first region 40 according to the timing at which the captured image is generated by the camera 50. For example, it is assumed that a predetermined number of captured images are used for calculation of the risk index value. In this case, at a timing at which a predetermined number of captured images not yet used for calculation of the risk index value of the first region 40 have been generated, the first calculation unit 2020 uses the predetermined number of captured images to calculate the risk index value of the first region 40. The information indicating the predetermined number may be preset in the first calculation unit 2020 or may be stored in a storage apparatus accessible from the first calculation unit 2020.

<Details of Extraction Unit 2040>

The extraction unit 2040 determines whether or not the risk index value of the first region 40 is equal to or greater than a threshold value (S106). Information indicating the threshold value may be preset in the extraction unit 2040 or may be stored in a storage apparatus accessible from the extraction unit 2040.

When the risk index value of the first region 40 is equal to or greater than the threshold value (S106: YES), the extraction unit 2040 extracts the bypass route 30 (S108). Here, it is assumed that one or more bypass routes have been defined in advance for the current route 20. Hereinafter, information in which the current route 20 is associated with the bypass route is referred to as bypass route information.

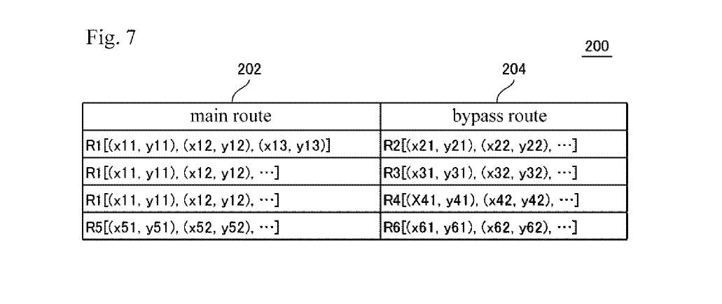

FIG. 7 is a diagram illustrating bypass route information in a table format. The route information 200 indicates a bypass route 204 for the main route 202. The current route 20 is a route indicated in one of the main routes 202.

The main route 202 and the bypass route 204 indicate arbitrary information with which the route can be determined. The information with which the route can be determined is, for example, position information of a start point of the route, an end point thereof, and a corner therebetween. The position information is, for example, global positioning system (GPS) coordinates. For example, in FIG. 7, the main route 202 of a record at a first row is a route R1 which departs from a start point (x11, y11), turns around a corner (x12, y12), and arrives at an end point (x13, y13).

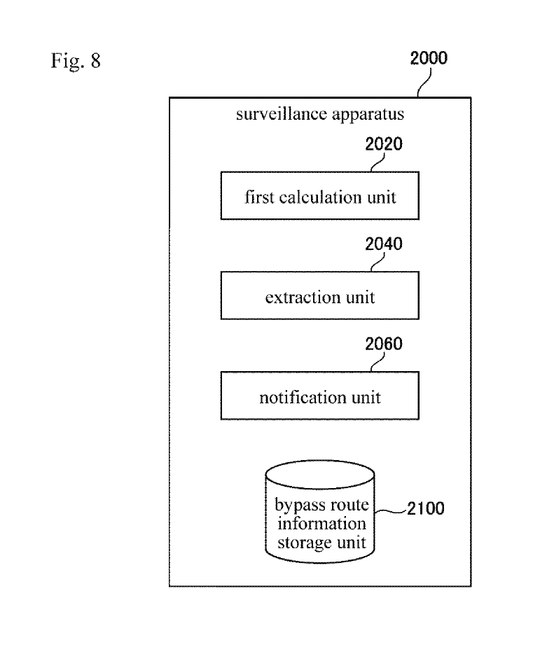

The route information 200 may be stored inside the surveillance apparatus 2000 or may be stored externally. FIG. 8 is a block diagram illustrating the surveillance apparatus 2000 including the bypass route information storage unit 2100. The bypass route information storage unit 2100 stores the route information 200.

The number of bypass routes 204 defined for one main route 202 may be one or may be plural. In FIG. 7, three bypass routes R2, R3, and R4 are defined for the main route R1. On the other hand, one bypass route R6 is defined for the main route R5.

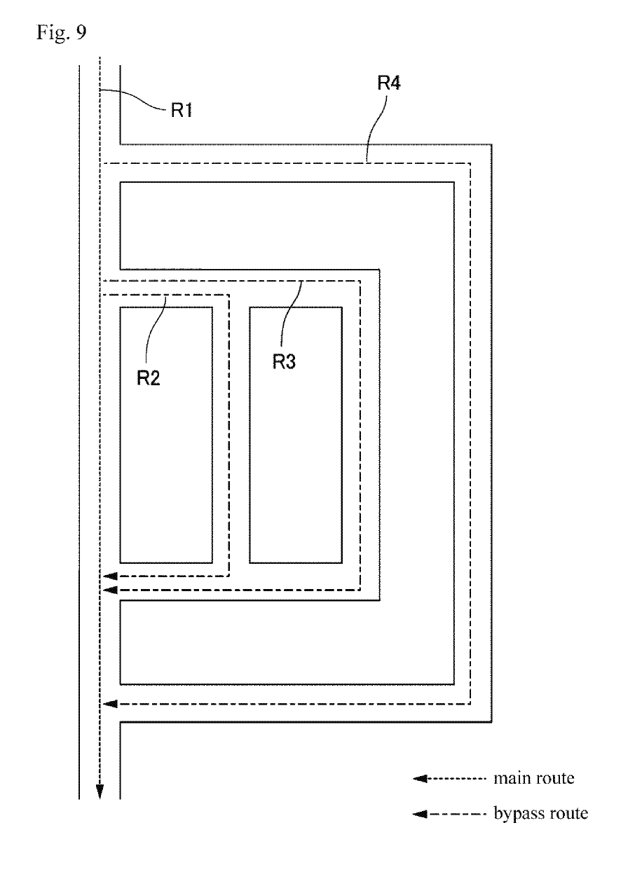

FIG. 9 is a diagram illustrating a plurality of bypass routes 204 for one main route 202. In FIG. 9, R1 is the main route 202, and R2 to R4 are bypass routes 204 corresponding to R1. Both the R2 and R3 have the same start point and the same end point, but have different corners in the way. Further, the start point and the end point of R4 are different from the start point and the end point of R2 and R3.

Note that the difference between the plurality of bypass routes 204 defined for the main route 202 is not limited to the difference illustrated in FIG. 9. For example, the two bypass routes 204 may be the same in one of the start point and the end point and may be different in the other.

When a plurality of bypass routes have been defined for the current route 20, the extraction unit 2040 extracts one of the plurality of bypass routes as the bypass route 30. Here, the extraction unit 2040 extracts the bypass route satisfying a condition that “the start point (a position entering the bypass route from the current route 20) of the bypass route is located in front of the first region 40 in a traveling direction of a person in the current route 20” as the bypass route 30. By using such a bypass route, it is possible to reduce the number of people passing through the first region 40, and it is therefore possible to reduce concern that a risk may occur due to congestion of people in the first region 40.

For example, the extraction unit 2040 extracts a bypass route that satisfies the above condition and the start point of which is closest to the first region 40 as the bypass route 30. Further, for example, the extraction unit 2040 extracts the bypass route satisfying the above condition and having the start point farthest from the first region 40 as the bypass route 30. Further, for example, the extraction unit 2040 extracts the bypass route satisfying the above condition and having the highest priority as the bypass route 30. In a case where the priority is used, the route information 200 indicates priorities of the respective bypass routes.

<Details of Notification Unit 2060>

The notification unit 2060 notifies the user of switching to the bypass route 30 (S110). Here, the information notified to the user is referred to as notification information. The notification information includes information for determining the bypass route 30. The information for determining the bypass route 30 is, for example, a name or an identifier determined in the bypass route 30, or a position or a name (such as a name of an intersection) of the start point of the bypass route 30.

For example, the notification unit 2060 transmits the notification information to the terminal of the user. When the user is an onsite security guard, the terminal of the user is, for example, a mobile terminal. When the user is a security guard at a security office, the terminal of the user is, for example, a PC, a server apparatus, or a mobile terminal.

The notification information is data in an arbitrary format such as text, image, or voice. The terminal of the user displays the notification information on a display or outputs the notification information as voice. Accordingly, the user can recognize the switching to the bypass route 30.

Here, the notification unit 2060 may transmit the notification information to all users of the surveillance apparatus 2000, or may transmit the notification information only to some of the users. In the latter case, for example, the notification unit 2060 determines the users that are transmission destinations according to the extracted bypass route 30. Specifically, the notification unit 2060 transmits the notification information to the users that are near the start point of the extracted bypass route 30. The position of the user can be recognized according to position information of the terminal of the user, or the like.

In a case where the route through which the person is caused to pass is to be switched to the bypass route 30, the security guard near the start point of the bypass route 30 needs to guide the person to the bypass route 30. Therefore, it is conceivable that there is a high necessity of acquiring the notification information from the notification unit 2060 for the security guard near the start point of the bypass route 30. On the other hand, it is conceivable that a security guard located far from the start point of the bypass route 30 is not involved in such guidance work in many cases. Therefore, it is conceivable that the necessity of acquiring the notification information from the notification unit 2060 is low for the security guard located far from the start point of the bypass route 30. Therefore, by the notification unit 2060 transmitting the notification information to only the terminal of the user who is near the start point of the bypass route 30, it is possible to prevent the notification information from being transmitted to a user for which the necessity of acquisition of the notification information is low. As a result, it is possible to prevent an unnecessary load from being applied to the surveillance apparatus 2000 or the terminal of each user.

Further, the notification unit 2060 may be configured to first transmit the notification information only to a terminal of a predetermined user. For example, a predetermined user is a responsible security guard who makes a final decision on switching to a bypass route. The responsible security guard who has received the notification information decides whether to perform switching to the bypass route 30 in consideration of various circumstances. For example, the responsible security guard inputs the determination result (information indicating whether or not to switch to the bypass route 30) to the terminal that the responsible security guard is using. This information is transmitted from the terminal of the responsible security guard to the surveillance apparatus 2000. When the information indicating the switching to the bypass route 30 is received, the notification unit 2060 transmits the notification information to other users. On the other hand, when information indicating that switching to the bypass route 30 is not performed is received, the notification unit 2060 does not transmit the notification information to the other users.

According to a method of operating security, there are cases where a responsible person who leads the guard, or the like has to make a determination regarding whether to perform switching to the bypass route. In such a case, as described above, it is preferable that the notification information is transmitted to the other users only in a case where a decision of “switching to the bypass route 30” is made by the responsible security guard or the like. By doing so, it is possible to prevent the notification information from being transmitted to an onsite security guard or the like in a case where the switching to the bypass route 30 is not performed. Therefore, more accurate information can be delivered to onsite security guard, and crowd guidance can be more appropriately performed.

### Application Example

The current route 20 through which a person is currently passing may be a bypass route of a certain main route. In this case, the route information 200 also indicates the route shown as the bypass route 204 for a certain main route 202 as the main route 202.

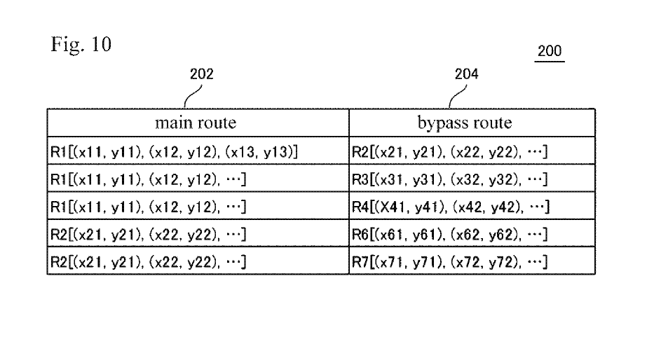

FIG. 10 is a diagram illustrating route information 200 under operation in which a certain bypass route can also become the main route. In FIG. 10, a route R2 is defined as a bypass route corresponding to the route R1 and is also defined as a main route corresponding to the bypass routes R6 and R7.

When a bypass route of a certain main route is treated as a current route 20, the surveillance apparatus 2000 extracts a bypass route that further bypasses a bypass route of a certain main route when a person is passing through the bypass route of the main route. The surveillance apparatus 2000 notifies the user of the fact that the route through which the person is caused to pass is to be the bypass route (the bypass route of the bypass route).

For example, it is assumed that when the current route 20 is R1, the route through which the person is caused to pass is to be switched to R2 of the bypass route. In this case, the surveillance apparatus 2000 treats R2 as the current route 20. When the risk index value of the first region 40 on the R2 is equal to or greater than the threshold value, the surveillance apparatus 2000 extracts R6 or R7 as the bypass route 30 and notifies the user of switching to the extracted bypass route 30.

By doing so, it is possible to notify the user of the switching to another bypass route that further bypasses such a bypass route in a case where there is high concern that a risk caused by congestion of people may occur in the bypass route. Therefore, it is possible to further reduce the concern that the risk caused by the congestion of people may occur on a route through which the person is caused to pass.

### Example Embodiment 2

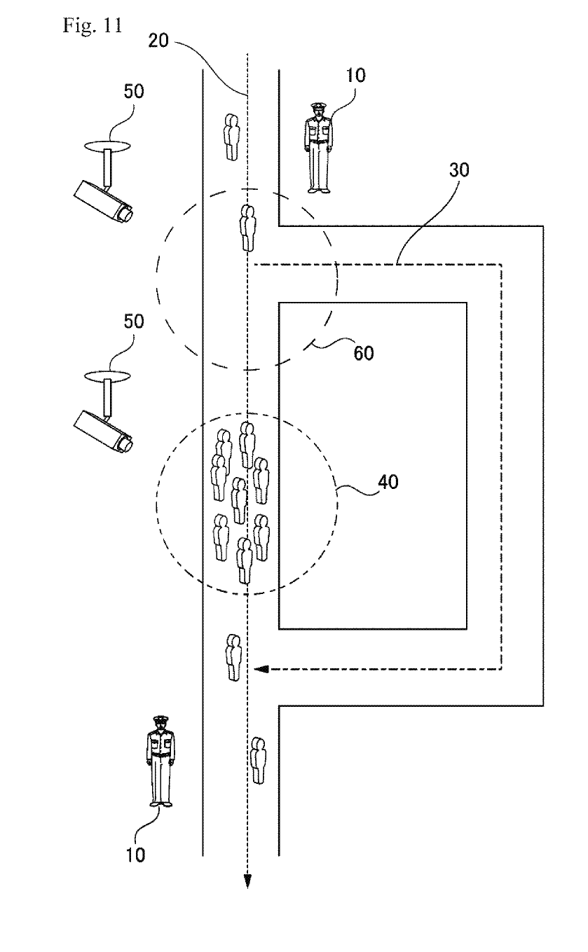

FIG. 11 is a diagram conceptually illustrating an operation of a surveillance apparatus 2000 according to Example Embodiment 2. The surveillance apparatus 2000 according to Example Embodiment 2 takes into consideration of concern of risk occurrence in the second region 60 which is another region on the current route 20, in addition to concern of risk occurrence in the first region 40 on the current route 20. Specifically, the surveillance apparatus 2000 according to Example Embodiment 2 notifies the user of the switching to the bypass route 30 in a case where the concern of the risk occurrence in the first region 40 on the current route 20 is high and the concern of the risk occurrence in the second region 60 which is another region on the current route 20 is low. Here, the second region 60 is located in front of the first region 40 in a traveling direction of a person passing through the current route 20. For example, the second region 60 is an intersection located at or near the start point of the bypass route 30.

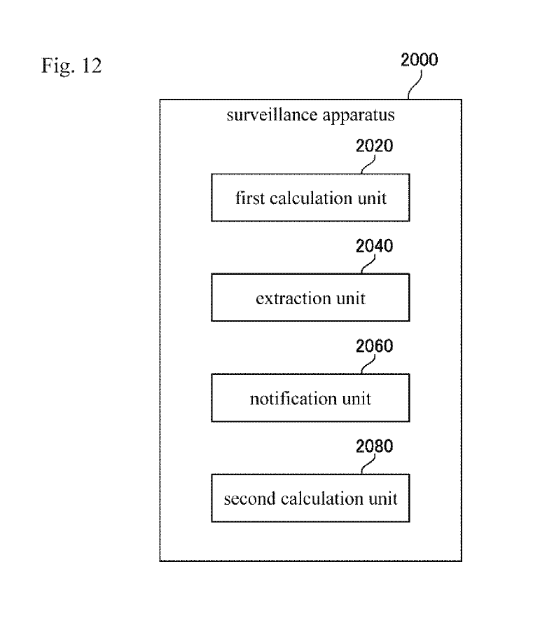

FIG. 12 is a block diagram illustrating the surveillance apparatus 2000 according to Example Embodiment 2. The surveillance apparatus 2000 of Example Embodiment 2 has the same function as the surveillance apparatus 2000 of Example Embodiment 1, except for the respects that will be described below.

The surveillance apparatus 2000 according to Example Embodiment 2 includes a second calculation unit 2080. The second calculation unit 2080 calculates a risk index value for the second region 60 on the current route 20. When the risk index value of the first region 40 is equal to or greater than the first threshold value and the risk index value of the second region 60 is equal to or smaller than the second threshold value, the notification unit 2060 notifies the user of the switching to the bypass route 30. Note that the second threshold value is smaller than the first threshold value. Information representing the first threshold value may be preset in the extraction unit 2040 or may be stored in a storage apparatus accessible from the extraction unit 2040. Similarly, the information indicating the second threshold value may be preset in the notification unit 2060 or may be stored in a storage apparatus accessible from the notification unit 2060.

<Flow of Process>

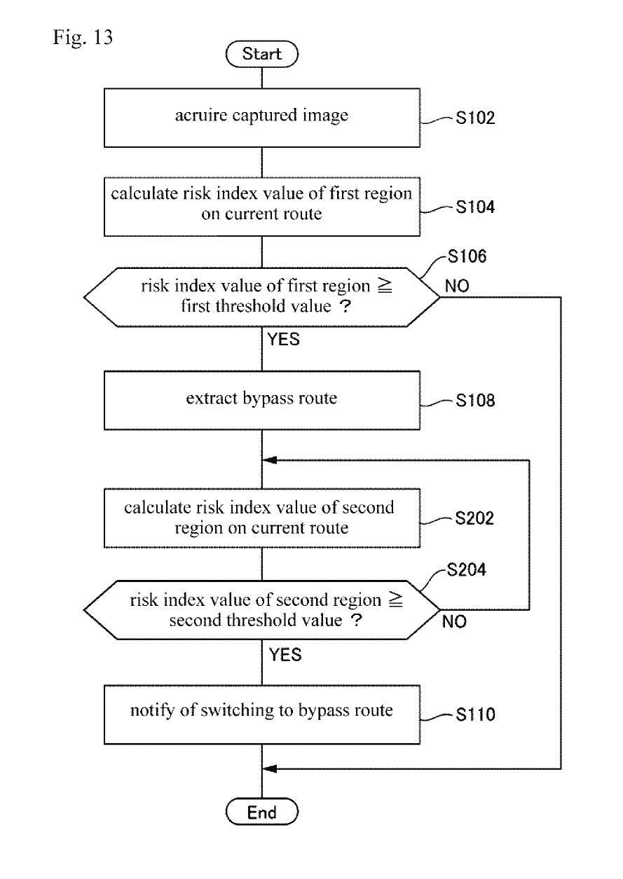

FIG. 13 is a flowchart illustrating a flow of a process that is executed by the surveillance apparatus 2000 according to Example Embodiment 2. Here, in FIGS. 13, S102 to S110 are the same processes as S102 to S110 in FIG. 4.

The surveillance apparatus 2000 according to Example Embodiment 2 executes steps S202 and S204 after executing S108 and before executing S110. In S202, the second calculation unit 2080 calculates the risk index value of the second region 60. In 5204, the notification unit 2060 determines whether or not the risk index value of the second region 60 is equal to or smaller than the second threshold value.

When the notification unit 2060 determines that the risk index value of the second region 60 is equal to or smaller than the second threshold value (S204: YES) in S204, the process of FIG. 13 proceeds to S110. As a result, the user is notified of the switching to the bypass route 30.

On the other hand, in S204, when the notification unit 2060 determines that the risk index value of the second region 60 is greater than the second threshold value (S210: NO), the process of FIG. 13 proceeds to S202. S202 and S204 are executed again. That is, according to the flow of the process illustrated in FIG. 13, the timing of notifying of the switching to the bypass route 30 is delayed until the risk index value of the second region 60 becomes equal to or smaller than the second threshold value.

<Details of Second Calculation Unit 2080>

The second calculation unit 2080 calculates a risk index value in the second region 60 on the current route 20 using the captured image generated by the camera 50. The camera 50 that generates the captured image that is used for calculation of the risk index value of the second region 60 is a fixed camera that is installed near the second region 60 or a moving camera that is moving near the second region 60. However, the camera 50 that generates the captured image that is used for calculation of the risk index value of the second region 60 is not limited to the illustrated camera.

Similar to the risk index value of the first region 40 described in Example Embodiment 1, the first calculation unit 2020 calculates the risk index value of the second region 60 on the basis of the density of the people in the second region 60, the temporal change in the density of the people, the speed of the person, the temporal change in the speed of the person, or a combination thereof.

The captured image that is used by the second calculation unit 2080 may be different from or may be the same as the captured image that is used by the first calculation unit 2020. Further, the second region 60 may be captured or the second region 60 may not be captured in the captured image for which the risk index value of the second region 60 is calculated. In a case where the second region 60 is not captured in the captured image, the second calculation unit 2080 calculates the estimated value of the density of the people, the temporal change in the density of the people, the speed of the person, or the temporal change in the speed of the person in the second region 60 to calculate the risk index value, using the same method as the method described in Example Embodiment 1.

Further, the second calculation unit 2080 may adjust the risk index value of the second region 60 on the basis of the attribute of the person located in the second region 60 using the same method as the method described in Example Embodiment 1. In this case, the notification unit 2060 compares the adjusted risk index value of the second region 60 with the second threshold value.

<Regarding Second Region>

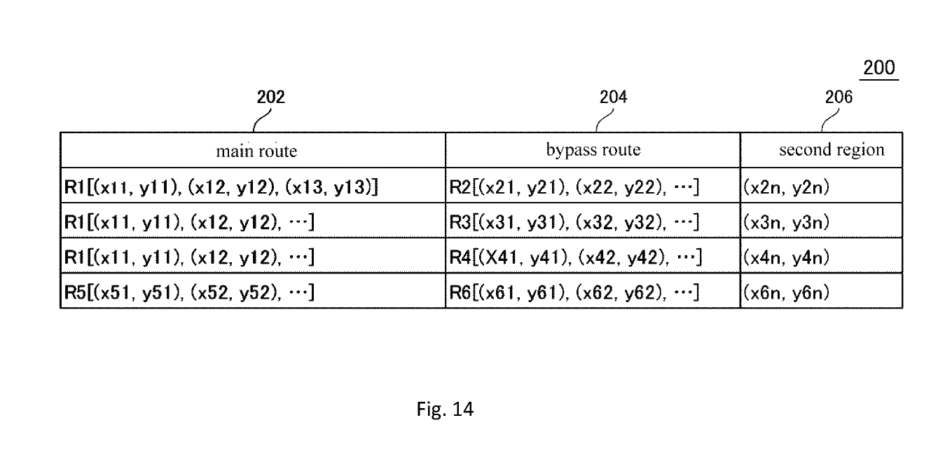

The second region 60 is defined in the route information 200 in associated with the bypass route 30. FIG. 14 is a diagram illustrating the route information 200 indicating the second region 60. In FIG. 14, the second region 206 indicates information (for example, position information of the second region 60) for defining the second region 60.

Switching from the current route 20 to the bypass route 30 is preferably performed at a timing at which concern that the risk caused by congestion of people may occur at or near the start point of the bypass route 30 is low (such as a timing at which the congestion occurs). This is because it is necessary to stop a flow of the crowd with the switching from the current route 20 to the bypass route 30. For example, when the second region 60 is an intersection located at or near the start point of the bypass route 30, a timing suitable for the switching to the bypass route 30 is, for example, a timing at which a signal of a crosswalk in a traveling direction of the current route 20 is a red signal. In this case, a flow of people in the traveling direction of the current route 20 stops in the bypass route 30 or near the bypass route 30. Therefore, the people can be safely guided to the bypass route 30.

Therefore, the second calculation unit 2080 calculates the risk index value for the second region 60 located at or near the start point of the bypass route 30. When the risk index value is smaller than the second threshold value, the notification unit 2060 notifies the user of the switching to the bypass route 30. For example, as described above, in a case where the second region 60 is an intersection, when the signal of the crosswalk in the traveling direction of the current route 20 becomes the red signal, the risk index value in the second region 60 becomes a small value.

Through such an operation of the surveillance apparatus 2000, it is possible to switch the route through which the person is caused to pass, to the bypass route 30 at a timing at which the concern that the risk caused by congestion of people may occur at or near the start point of the bypass route 30 is low. Therefore, it is possible to more reliably prevent the risk caused by congestion of people from occurring on the current route 20.

<Example of Hardware Configuration>

A hardware configuration of the surveillance apparatus 2000 according to Example Embodiment 2 is represented by, for example, FIG. 3, as in the surveillance apparatus 2000 of Example Embodiment 1. The storage 1080 of Example Embodiment 2 includes a program for realizing respective functions (the functions of the first calculation unit 2020, the extraction unit 2040, the notification unit 2060, and the second calculation unit 2080) of Example Embodiment 2 described above.

### Advantageous Effects

According to the example embodiment, when the risk index value of the first region 40 is equal to or greater than the first threshold value and the risk index value of the second region 60 is equal to or smaller than the second threshold value, the user is notified that the switching to the bypass route 30 is performed. By doing this, it is possible to more reliably prevent a risk caused by congestion of people on the current route 20 from occurring.

### Modification Example of Second Example Embodiment

As described above, when the risk index value of the first region 40 is equal to or greater than the first threshold value and the risk index value of the second region 60 is equal to or smaller than the second threshold value, the notification unit 2060 of Example Embodiment 2 notifies the user of the switching to the bypass route 30. However, in a case where the risk index value of the first region 40 is equal to or greater than the first threshold value and the risk index value of the second region 60 exceeds the second threshold value, the notification unit 2060 of Example Embodiment 2 may also notify the user of a certain notification. The certain notification is, for example, a notification of information indicating that concern that a risk caused by congestion of people may occur in the first region 40 is high, or information indicating the degree of the concern (such as the first threshold value).

By making such a notification when the risk index value of the first region 40 is equal to or greater than the first threshold value and the risk index value of the second region 60 exceeds the second threshold value, the user of the surveillance apparatus 2000 can urgently recognize that the concern that the risk caused by congestion of people may occur is high in the first region 40.

Although the example embodiments of the present invention have been described with reference to the drawings, these are examples of the present invention, and combinations of the above example embodiments or various other configurations can also be adopted.

Hereinafter, examples of a reference form will be added.

1. A surveillance apparatus including:

a first calculation unit calculating a first risk index value using a captured image in which a current route through which a person is caused to pass, the first risk index value indicating a degree of concern that a risk caused by congestion of people may occur in a first region on the current route;

an extraction unit extracting one of one or more bypass routes that are defined for the current route when the first risk index value is equal to or greater than a first threshold value; and

a notification unit notifying that a route through which the person is caused to pass is to be switched from the current route to the extracted bypass route.

2. The surveillance apparatus according to 1., wherein the first calculation unit calculates a density of people in the first region, a temporal change in the density of the people, a speed of a person in the first region, or a temporal change in the speed of the person, as the first risk index value.

3. The surveillance apparatus according to 2., wherein the first calculation unit performs:

calculating the temporal change in the density of the people in the first region, on the basis of a density of people in a region in front of or behind the first region in the traveling direction of the person in the current route;

calculating the density of the people in the first region, on the basis of a temporal change in the density of people in a region in front of or behind the first region in the traveling direction of the person in the current route;

calculating the speed of the people in the first region, on the basis of a speed of people in a region in front of or behind the first region in the traveling direction of the person in the current route; or

calculating the temporal change in the speed of the people in the first region, on the basis of a temporal change in the speed of people in a region in front of or behind the first region in the traveling direction of the person in the current route.

4. The surveillance apparatus according to any one of 1. to 3.,

wherein the first calculation unit adjusts the calculated first risk index value on the basis of an attribute of a person located in the first region, and

the extraction unit uses the adjusted first risk index value.

5. The surveillance apparatus according to any one of 1. to 4., further including:

a second calculation unit calculating a second risk index value indicating a degree of concern that a risk caused by congestion of people may occur in a second region, the second region being in front of the first region in the traveling direction of the person in the current route,

wherein the notification unit notifies that a route through which the person is caused to pass is to be switched from the current route to the extracted bypass route when the second risk index value is equal to or smaller than a second threshold value, and

the second threshold value is smaller than the first threshold value.

6. The surveillance apparatus according to 5., wherein the second region is a region at or near a start point of the extracted bypass route.

7. The surveillance apparatus according to 5. or 6., wherein the second calculation unit calculates a density of people in the second region, a temporal change in the density of the people, a speed of a person in the second region, or a temporal change in the speed of the person, as the second risk index value.

8. The surveillance apparatus according to 7.,

wherein the second calculation unit performs:

calculating the density of the people in the second region, on the basis of a density of people in a region in front of or behind the second region in the traveling direction of the person in the current route;

calculating the temporal change in the density of the people in the second region, on the basis of a temporal change in the density of people in a region in front of or behind the second region in the traveling direction of the person in the current route;

calculating the speed of the people in the second region, on the basis of a speed of people in a region in front of or behind the second region in the traveling direction of the person in the current route; or

calculating the temporal change in the speed of the people in the second region, on the basis of a temporal change in the speed of people in a region in front of or behind the second region in the traveling direction of the person in the current route.

9. The surveillance apparatus according to any one of 6. to 8.,

wherein the second calculation unit adjusts the calculated second risk index value on the basis of an attribute of a person located in the second region, and

the notification unit uses the adjusted second risk index value.

10. The surveillance apparatus according to any one of 1. to 9., further including:

a bypass route information storage unit storing bypass route information for associating bypass routes of the current route with the current route,

wherein the extraction unit extracts one of the bypass routes associated with the current route in the bypass route information.

11. A control method that is executed by a computer, the control method including:

a first calculation step of calculating a first risk index value using a captured image obtained by imaging a current route through which a person is caused to pass, the first risk index value indicating a degree of concern that a risk caused by congestion of people may occur in a first region on the current route;

an extraction step of extracting one of one or more bypass routes that are defined for the current route when the first risk index value is equal to or greater than a first threshold value; and

a notification step of notifying that a route through which the person is caused to pass is to be switched from the current route to the extracted bypass route.

12. The control method according to 11., wherein the first calculation step includes calculating a density of people in the first region, a temporal change in the density of the people, a speed of a person in the first region, or a temporal change in the speed of the person, as the first risk index value.

13. The control method according to 12.,

wherein the first calculation step includes:

calculating the density of the people in the first region, on the basis of a density of people in a region in front of or behind the first region in the traveling direction of the person in the current route;

calculating the temporal change in the density of the people in the first region, on the basis of a temporal change in the density of people in a region in front of or behind the first region in the traveling direction of the person in the current route;

calculating the speed of the people in the first region, on the basis of a speed of people in a region in front of or behind the first region in the traveling direction of the person in the current route; or

calculating the temporal change in the speed of the people in the first region, on the basis of a temporal change in the speed of people in a region in front of or behind the first region in the traveling direction of the person in the current route.

14. The control method according to any one of 11. to 13.,

wherein the first calculation step includes adjusting the calculated first risk index value on the basis of an attribute of a person located in the first region, and

the extraction step includes using the adjusted first risk index value.

15. The control method according to any one of 11. to 14., further including:

a second calculation step of calculating a second risk index value indicating a degree of concern that a risk caused by congestion of people may occur in a second region, the second region being in front of the first region in the traveling direction of the person in the current route,

wherein the notification step includes notifying that a route through which the person is caused to pass is to be switched from the current route to the extracted bypass route when the second risk index value is equal to or smaller than a second threshold value, and

the second threshold value is smaller than the first threshold value.

16. The control method according to 15., wherein the second region is a region at or near a start point of the extracted bypass route.

17. The control method according to 5. or 6., wherein the second calculation step includes calculating a density of people in the second region, a temporal change in the density of the people, a speed of a person in the second region, or a temporal change in the speed of the person, as the second risk index value.

18. The control method according to 17,

wherein the second calculation step includes:

calculating the density of the people in the second region, on the basis of a density of people in a region in front of or behind the second region in the traveling direction of the person in the current route;

calculating the temporal change in the density of the people in the second region, on the basis of a temporal change in the density of people in a region in front of or behind the second region in the traveling direction of the person in the current route;

calculating the speed of the people in the second region, on the basis of a speed of people in a region in front of or behind the second region in the traveling direction of the person in the current route, or

calculating the temporal change in the speed of the people in the second region on the basis of a temporal change in the speed of people in front of or behind the second region in the traveling direction of the person in the current route.

19. The control method according to any one of 16. to 18.,

wherein the second calculation step includes adjusting the calculated second risk index value on the basis of an attribute of a person located in the second region, and

the notification step includes using the adjusted second risk index value.

20. The control method according to any one of 11. to 19., further including:

a bypass route information storage step for storing bypass route information for associating bypass routes of the current route with the current route,

wherein the extraction step includes extracting one of the bypass routes associated with the current route in the bypass route information.

21. A program that causes a computer to execute each step of the control method according to any one of 11. to 20..

22. An imaging apparatus including:

an imaging unit generating a captured image by imaging a current route through which a person is caused to pass;

a first calculation unit calculating a first risk index value indicating a degree of concern that a risk caused by congestion of people may occur in a first region on the current route using the captured image;

an extraction unit extracting one of one or more bypass routes defined for the current route when the first risk index value is equal to or greater than a first threshold value; and

a notification unit notifying that a route through which the person is caused to pass is to be switched from the current route to the extracted bypass route.

1. A surveillance system comprising:
at least one memory storing instructions; and
at least one processor coupled to the at least one memory, the at least one processor being configured to execute the instructions to:
acquire a first captured image generated by capturing a region on a current route which people are passing through;
calculate a first risk index value which indicates degree of risk caused by congestion of people in a first region on the current route, based on an observed value with regard to people in the captured image;
acquire a second captured image generated by capturing a second region which is associated with a bypass route which is determined for the current route;
calculate a second risk index value which indicates degree of risk caused by congestion of people in the second region, based on an observed value with regard to people in the second captured image; and
output a notification indicating that a route which people are guided to should be switched from the current route to the bypass route, at a timing when the second risk index value gets to be equal to or smaller than a second threshold value after the first risk index value become equal to or larger than a first threshold value.

2. The surveillance system according to claim 1, wherein the at least one processor is further configured to
calculate the first risk index value by using speeds of the people in the captured image.

3. The surveillance system according to claim 1, wherein the at least one processor is further configured to
calculate the second risk index value by using a density of the people in the captured image.

4. The surveillance system according to claim 1, wherein
the second threshold value is smaller than the first threshold value.

5. The surveillance system according to claim 1, wherein the at least one processor is further configured to:
adjust at least one of the calculated first risk index value and/or the calculated second risk index value based on an attribute of persons located in the first region and/or the second region; and
use the adjusted first and/or second risk index value.

6. A surveillance method comprising:
acquiring a first captured image generated by capturing a region on a current route which people are passing through;
calculating a first risk index value which indicates degree of risk caused by congestion of people in a first region on the current route, based on an observed value with regard to people in the captured image;
acquiring a second captured image generated by capturing a second region which is associated with a bypass route which is determined for the current route;
calculating a second risk index value which indicates degree of risk caused by congestion of people in the second region, based on an observed value with regard to people in the second captured image; and
outputting a notification indicating that a route which people are guided to should be switched from the current route to the bypass route, at a timing when the second risk index value gets to be equal to or smaller than a second threshold value after the first risk index value become equal to or larger than a first threshold value.

7. The surveillance method according to claim 6, further comprising
calculating the first risk index value by using speeds of the people in the captured image.

8. The surveillance method according to claim 6, further comprising
calculating the second risk index value by using a density of the people in the captured image.

9. The surveillance method according to claim 6, wherein
the second threshold value is smaller than the first threshold value.

10. The surveillance method according to claim 6, further comprising:
adjusting at least one of the calculated first risk index value and/or the calculated second risk index value based on an attribute of persons located in the first region and/or the second region; and
using the adjusted first and/or second risk index value.

11. A non-transitory computer-readable storage medium storing a program that causes a computer to perform:
acquiring a first captured image generated by capturing a region on a current route which people are passing through;
calculating a first risk index value which indicates degree of risk caused by congestion of people in a first region on the current route, based on an observed value with regard to people in the captured image;
acquiring a second captured image generated by capturing a second region which is associated with a bypass route which is determined for the current route;
calculating a second risk index value which indicates degree of risk caused by congestion of people in the second region, based on an observed value with regard to people in the second captured image; and
outputting a notification indicating that a route which people are guided to should be switched from the current route to the bypass route, at a timing when the second risk index value gets to be equal to or smaller than a second threshold value after the first risk index value become equal to or larger than a first threshold value.

12. The storage medium according to claim 11, wherein the program further causes the computer to perform
calculating the first risk index value by using speeds of the people in the captured image.

13. The storage medium according to claim 11, wherein the program further causes the computer to perform
calculating the second risk index value by using a density of the people in the captured image.

14. The storage medium according to claim 11, wherein the program further causes the computer to perform
the second threshold value is smaller than the first threshold value.

15. The storage medium according to claim 11, wherein the program further causes the computer to perform:
adjusting at least one of the calculated first risk index value and/or the calculated second risk index value based on an attribute of persons located in the first region and/or the second region; and
using the adjusted first and/or second risk index value.
